(19) United States
(12) Patent Application Publication
(10) Pub. No.: US 2010/0042527 A1
(43) Pub. Date: Feb. 18, 2010

(54) Storm Commodity Forecast System and Method

(75) Inventors: Stephen John Mitchell, Bellaire, TX (US); Carlton Craig Haynie, Cypress, TX (US)

Correspondence Address: HAYNES AND BOONE, LLP;IP Section, 2323 Victory Avenue, Suite 700, Dallas, TX, 75219, US

(73) Assignee: WEATHER INSIGHT, LP, Houston, TX (US)

(21) Appl. No.: 12/501,036

(22) Filed: Jul. 10, 2009

Related U.S. Application Data
(60) Provisional application No. 61/079,736, filed on Jul. 10, 2008.

(51) Int. Cl. G06Q 40/00; G01W 1/00

(52) U.S. Cl. 705/35; 702/3

(57) ABSTRACT

A method, system, and software package configured to receive, process, compile, and transmit commodity trading information to selected users is provided. The weather information and commodity production information are generally received from remote databases, processed by an internal forecast data server in light to determine the potential short-term or long-term effects on commodities that a forecasted storm will have. The data may then be transmitted to users via a web-based application or in accordance with predetermined parameters that may be set by the users themselves.

### CROSS REFERENCE TO RELATED APPLICATIONS

This application claims the benefit of U.S. Provisional Patent Application Ser. No. 61/079,736, filed on Jul. 10, 2008, the entirety of which is incorporated by reference herein.

### BACKGROUND

Embodiments of the invention are related to methods, systems, and software configured to upload weather data from a database, process said weather data, and more efficiently distribute commodity-related weather information to users without requiring time consuming analysis by a meteorologist.

Most traded commodities are influenced in some way by weather. For example, energy is a particularly weather-sensitive commodity that is traded on national and international markets. In order to support or facilitate the trading of these weather-dependent commodities, several entities around the globe distribute weather forecasts that are used and interpreted by meteorologists to be applied to commodity trading.

For example, the National Weather Service (NWS) issues a comprehensive package of weather-related information, including extended forecasts for various regions around the globe, at regular intervals to support a variety of users. From the extended forecast information provided by sources such as the NWS, national maps portraying the weather forecast changes are generated by trained meteorologists. The meteorologist may then analyze the maps' incipient changes to create conclusory opinions regarding the directional momentum of future weather trends. Using these opinions, a commodity trader may then execute an informed energy commodity trade.

One extremely volatile directional momentum includes tropical storm tracking in the Tropical Atlantic Ocean region, and in particular amidst the continental shelf of the Gulf of Mexico where several deep-water offshore oil and gas platforms are located. It is commonly observed that as soon as there is even a remote possibility of a storm forming and entering the Gulf of Mexico region, the energy market fluctuates. How significantly the market will ultimately be affected depends on whether the storm actually develops into a tropical depression or worse.

Today, with increasingly improved accuracy, weather forecasters are able to prognosticate a likely storm trajectory well in advance of the storm's actual movement. In cases where a potentially dangerous storm forms in the Tropical Atlantic region and threatens to enter the Gulf of Mexico, a typical offshore oil or natural gas platform or facility will decide whether to evacuate the facility by either a short-term shut-in or a long-term halt of production. What really affects and moves the market is the forecasted probability of long-term damage to oil and gas producing facilities, since damage sustained by an offshore facility may result in a halt in production for weeks or even months. These delays directly affect the supply and demand of the energy market and, in light of such potential losses, energy markets react by aggressively buying or selling commodity futures accordingly.

What is needed, then, is a system and method designed to accurately calculate the potential formation of tropical storms as well as the potential offshore production loss of oil barrels per day and billion cubic feet (BCF) of natural gas per day based upon the forecasted storm path. Also needed is a system and method to accurately calculate potential production/output losses to onshore refineries and power plants based upon the forecasted storm path.

### SUMMARY OF THE DISCLOSURE

Embodiments of the present disclosure generally allow a user to bypass the time-consuming weather analysis and forecasting steps that are part of conventional weather-related commodity trading processes. Said embodiments may provide a user with near real-time weather data via a system and method configured to evaluate forecasted weather and convert it into near real-time forecasted commodity-related trading information.

Specifically, the present disclosure may be configured to calculate and provide users with a quantitative analysis of offshore and onshore energy production as it may be impacted by impending tropical storms. In at least one embodiment, energy production consists of oil and natural gas production. Once a weather forecasting source declares a storm to be a bone fide tropical depression or greater, the system of the present disclosure may be configured to immediately convert the weather forecast data into a quantifiable number of daily barrels of oil and billion cubic feet (BCF) of natural gas that may be affected based upon the storm's projected trajectory which may potentially encompass several offshore production facilities. By knowing the production capacity and location of each offshore and onshore production facility, the likelihood of a short-term shut-in or long-term damage to the facility may be calculated, and signals can be generated that will inform commodity traders of the potential impact the forecasted storm will have on the future supply of crude oil and natural gas.

Similar calculations and prognostications can be made for crude oil refineries across the Gulf of Mexico and North America. When any of these forecasts and calculations or changes thereto occur, commodity traders may be alerted to the significant developments in a variety of formats. Also within the scope of this disclosure is providing calculations and prognostications for natural gas refineries, hydroelectric power plants, nuclear power plants and coal power plants similarly situated.

The present disclosure utilizes a geographic information system (GIS-based) interface that captures, stores, analyzes, manages and presents data and associated energy and weather attributes that are spatially referenced to the globe. This may include a web-based application that a user may access to retrieve the forecasted commodity data based on a forecasted tropical storm.

The present disclosure allows a user to estimate short-term disruptions of daily offshore production of crude oil and natural gas which is likely to come offline due to tropical activity. A user will also be able to quickly assess production that is likely to sustain longer-term disruption due to storm damage. Also disclosed is the ability to predict the potential loss of onshore refining capacity due to gale and/or hurricane force winds and further monitor the potential loss of electricity generation.

An exemplary method for compiling and transmitting weather-related data to a user is herein disclosed. The method may include downloading weather information from a weather information database communicably coupled to a forecast data server, wherein the weather information includes a forecasted trajectory of a storm, downloading commodity production information from a commodity production database communicably coupled to the forecast data server, transmitting the weather information and commodity production information to the forecast data server, processing the transmitted weather information and commodity production information to determine possible short-term shut-in or susceptible long-term damages for offshore oil or natural gas facilities lying in the forecasted trajectory of the storm, wherein a commodity forecast is obtained, and transmitting the commodity forecast to the user via a communication module, wherein the user may specify at least one pre-determined parameter so as to receive a personalized commodity forecast.

An exemplary system for compiling and transmitting weather-related data to a user is also disclosed herein. The system may include a forecast data server, a weather information database communicably coupled to the forecast data server and configured to provide the forecast data server with near real-time weather forecasts, including a forecasted trajectory of an impending tropical storm, wherein the weather information database is stored on a computer-readable medium, a commodity production database stored on a computer-readable medium, communicably coupled to the forecast data server, and configured to transmit to the forecast data server production information relating to crude oil and natural gas production for offshore facilities and/or refineries, wherein the forecast data server is configured to process the information received from the weather information database and commodity production database to obtain a commodity forecast, and a communication module communicably coupled to the forecast data server and configured to distribute the commodity forecast to the user.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic of a system for providing a commodity forecast to a user, according to at least one embodiment of the present disclosure.

FIG. 2 is a graphical user interface illustrating an exemplary forecasted storm path with offshore and onshore production.

FIG. 3 is a table depicting a forecasted loss of commodity production in light of the forecasted storm path from FIG. 1.

FIG. 4 is a table depicting a forecasted loss of energy output from refineries in light of the forecasted storm path from FIG. 1.

FIG. 5 is a graphical user interface illustrating a report detailing probability analyses for a current tropical storm.

FIG. 6 illustrates a schematic of a method for providing a commodity forecast to a user, according to at least one embodiment of the present disclosure.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure, however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Also, the exemplary embodiments presented below may be combined in any combination of ways, i.e., any element from one exemplary embodiment may be used in any other exemplary embodiment, without departing from the scope of the disclosure.

Certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. In the following discussion and in the claims, the terms “including” and “comprising” are used in an open-ended fashion, and thus should be interpreted to mean “including, but not limited to.” Any and all numerical values in this disclosure may be exact or approximate values unless otherwise specifically stated. Accordingly, various embodiments of the disclosure may deviate from the numbers, values, and ranges disclosed herein without departing from the intended scope.

The foregoing disclosure may include a computer system which typically includes hardware capable of executing machine-readable instructions, as well as the software for executing the machine-readable instructions to produce a desired result. Hardware generally includes at least processor-capable platforms, such as client-machines (also known as personal computers or servers), and hand-held processing devices (such as smart phones, personal digital assistants (PDAs), or personal computing devices (PCDs), for example). Further, hardware may include any physical device that is capable of storing machine-readable instructions, such as memory or other data storage devices. Other forms of hardware include hardware sub-systems, including transfer devices such as modems, modem cards, ports, and port cards.

Software includes any machine code stored in any memory medium, such as RAM or ROM, and machine code stored on other devices, such as floppy disks, flash memory, hard drives, network drives, or a CD ROM. Software may include source or object code, for example. In addition, software encompasses any set of instructions capable of being executed in a client machine or server. Software may include one or more logical units known as modules.

In describing selected embodiments, various objects or components may be implemented as computing modules. These modules may be general-purpose, or they may have dedicated functions such as memory management, program flow, instruction processing, object storage, etc. The modules can be implemented in any way known in the art. One or more of the modules may also be implemented in programmable hardware devices such as field programmable gate arrays, programmable array logic, programmable logic devices or the like.

In an exemplary embodiment, one or more of the modules may be implemented in software for execution by various types of processors. An identified module of executable code may, for instance, include one or more physical or logical blocks of computer instructions that may, for instance, be organized as an object, procedure, or function. A “module” of executable code could be a single instruction, or many instructions, and may be distributed over several different code segments, among different programs, and across several memory devices. Similarly, operational data may be identified and illustrated in association with one or more modules, and may be embodied in any suitable form and organized within any suitable type of data structure. The operational data may be collected as a single data set, or may be distributed over different locations including over different storage devices, and may exist, at least partially, as electronic signals on a system or network.

One type of module is a “network.” A network module defines a communications path between endpoints and may include an arbitrary amount of intermediate modules. A network module may encompass various pieces of hardware, such as cables, routers, and modems, as well the software necessary to use that hardware. Another network module may encompass system calls or device-specific mechanisms such as shared memory, pipes, or system messaging services. A third network module may use calling conventions within a computing module, such as a computer language or execution environment. Information transmitted using the network module may be carried upon an underlying protocol, such as HTTP, BXXP, or SMTP, or it may define its own transport over TCP/IP, IPX/SPX, Token Ring, ATM, etc. Further, a network module may transform the data through the use of one or more computing modules.

Combinations of software and hardware may be used for providing enhanced functionality and performance for certain embodiments of the present disclosure. One example is to directly provide a quantitative analysis of offshore and onshore energy production as it may be impacted by impending tropical storms. Accordingly, it should be understood that combinations of hardware and software are also included within the definition of a computer system and are thus envisioned by the present disclosure as possible equivalent structures and equivalent methods.

Data structures are defined organizations of data that may enable an embodiment of the invention. For example, a data structure may provide an organization of data, or an organization of executable code. Data signals could be carried across transmission mediums and store and transport various data structures, and, thus, may be used to transport an embodiment of the invention.

In at least one embodiment, the present disclosure may be designed to work on any specific architecture. For example, the system may be executed on a single computer, through local area networks, client-server networks, wide area networks, internets, hand-held and other portable and wireless devices and networks. The methods described herein may be implemented using software encoded on a computer-readable medium. Further, methods described herein may also be implemented using hardware configured to carry out the methods.

A database, as described herein, may be any standard or proprietary database software, such as Oracle, Microsoft Access, SyBase, or DBase II, for example. The database may have fields, records, data, and other database elements that may be associated through database specific software. Additionally, data may be mapped, or associating one data entry with another data entry. For example, the data contained in the location of a character file can be mapped to a field in a second table. The physical location of the database is not limiting, and the database may be distributed. For example, the database may exist remotely from the server, and run on a separate platform. Further, the database may be accessible across the Internet. It is to be understood that more than one database may be implemented.

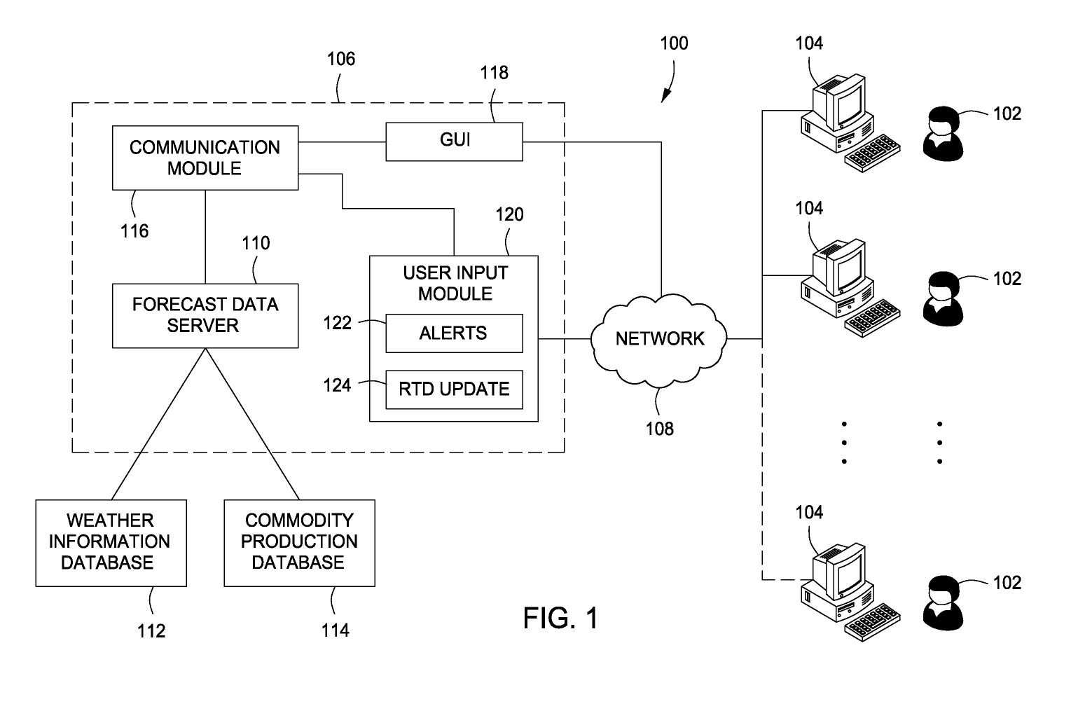

Referring to FIG. 1, illustrated is a schematic of an exemplary commodity forecast system 100, according to at least one embodiment of the present disclosure. The system 100 may be configured to evaluate and quantify weather forecasts, and convert them into near real-time forecasted commodity-related trading information available to at least one user 102. In an exemplary embodiment, the user 102 may include an energy commodity trader.

The system 100 may be accessed by one or more users 102 via a user interface 104. The user interface 104 may be any form factor, including without limitation a desktop computer or a mobile computing device. In an exemplary embodiment, the user interface 104 may include a CPU and a memory (not shown), and may also include an operating system (“OS”) that controls the operation of the user interface 104. The OS may be a Microsoft Windows OS, but in other embodiments, the OS may be any kind of operating system, including without limitation any version of the Linux OS, any version of the Unix OS, or any other conventional OS as is known in the art.

In an exemplary embodiment, a user 102 may provide the user interface 104 input using a keyboard and mouse, or any conventional peripheral adapted to receive input and provide it to the OS. In turn, the user interface 104 may provide the user 102 with output using a printer or a monitor, or any conventional peripheral adapted to provide output from the OS to the user 102. In at least one embodiment, the monitor may provide the user 102 with at least one graphical user interface (GUI), enabling the user 102 to interactively communicate with the system 100.

Each user interface 104 may be communicably coupled to an Operational Center (OC) 106 via a network 108. The network 108 may be the Internet, however, in other embodiments the network 108 may be an intranet or any other network known in the art. The OC 106 may conveniently house at least one forecast data server 110, communicably connected to at least one weather information database 112. The weather information database 112 may be configured to provide the forecast data server 110 with current weather data forecasts immediately, or in near real-time, after the information is made available. The weather information database 112 may receive weather forecast data from a plurality of possible sources, such as government weather information sources, educational institutions, privately operated weather information sources, and/or various other public or private meteorological information sources. For example, the government-operated National Weather Service (NWS) is a typical source to acquire current weather-related information made available to the general public.

The forecast data server 110 may also be communicably connected to at least one commodity production database 114 configured to provide the server 110 with current information related to crude oil and natural gas production for all producing facilities. The commodity production database 114 may also provide the server 110 with current information regarding energy production facilities, such as onshore and offshore drilling facilities, crude oil refineries, pipelines, and power plants. Such information may include the total oil and gas production numbers, the total power output numbers, and the total losses numbers in the event a facility is required to either minimize production, or halt all operations entirely.

Such detailed information, like production numbers and statistics, are all publicly available and disseminated on a periodic basis through the Minerals Management Service, an agency of the U.S. Government, which requires drillers by law to report production numbers. These government updates are typically offered periodically. Hence, one function of the commodity production database 114 may be to identify what the government numbers will report in the future, either hours, days, or weeks in advance of the official government report. Therefore, the commodity production database 114 may be configured to periodically troll the information outlets of sources such as the Minerals Management Service and automatically download that data to the forecast data server 110 for processing. In at least one embodiment, however, the commodity production database 114 may be configured to continuously troll the information outlets so as to provide a near-real time reporting of forecast changes or updates.

Thus, the forecast data server 110 may be configured to constantly receive current weather forecast updates from the weather information database 112 and current information related to crude oil and natural gas production for all producing facilities from the commodity production database 114. Once the collective information is obtained, it is then processed and compiled in accordance with at least one predetermined algorithm configured to calculate the potential losses in oil and gas production and power generation in light of a forecasted storm trajectory. The forecast data server 110 may then be configured to distribute this compiled commodity forecast information to selected users 102, as explained below.

To facilitate the distribution of the compiled commodity forecast information, the OC 106 may also house a communication module 116 communicably coupled to the forecast data server 110. The communication module 116 may be configured to distribute the data via a variety of formats. For example, the communication module 116 may provide the user 102 with a graphical user interface (GUI) 118 viewable via the user interface 104, e.g., a monitor attached thereto. As explanation, the communication module 116 may include software that is responsible for graphic or animation data processing configured to process, or convert, the results of the data processing undertaken by the forecast data server 110 into visible graphic images for user 102 reference via the user interface 104. In particular, by way of linked computer-generated visual displays, commonly identified as pages, windows or screens, which have an integrated graphic user interface (GUI) 118, the user 102 can input and view information processed by the forecast data server 110.

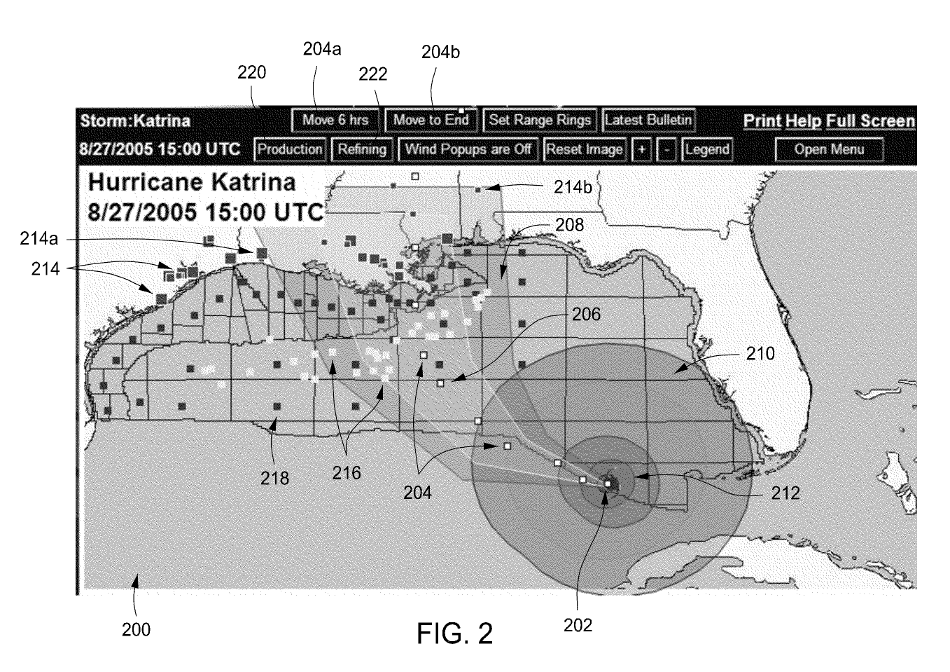

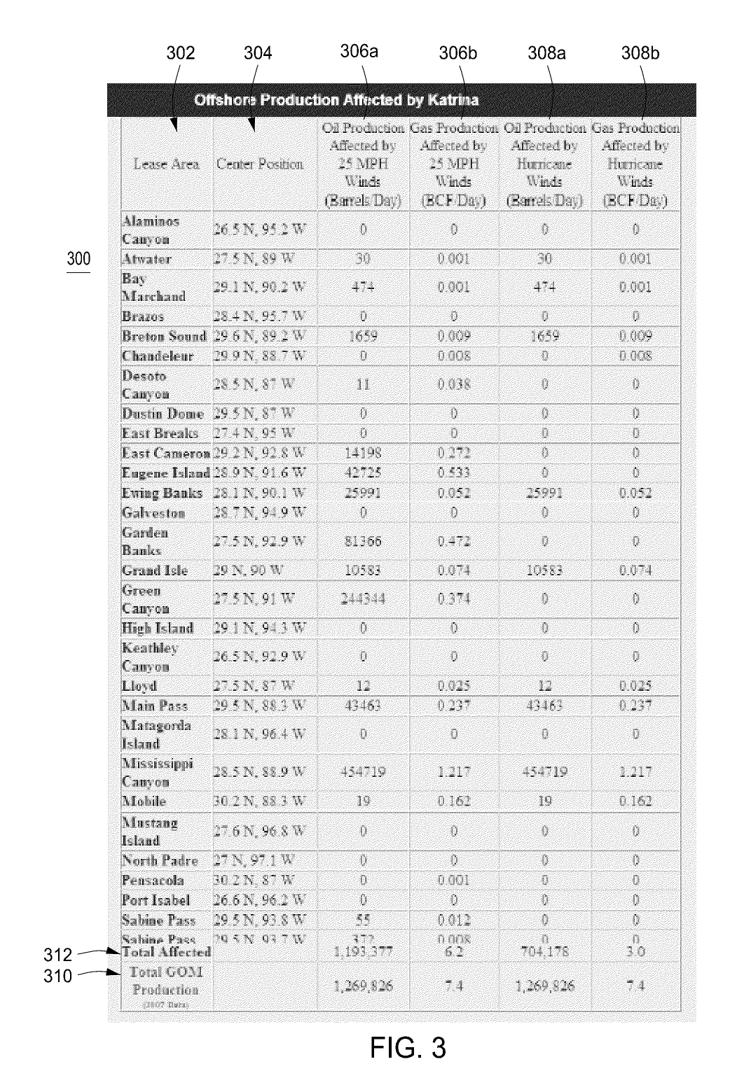

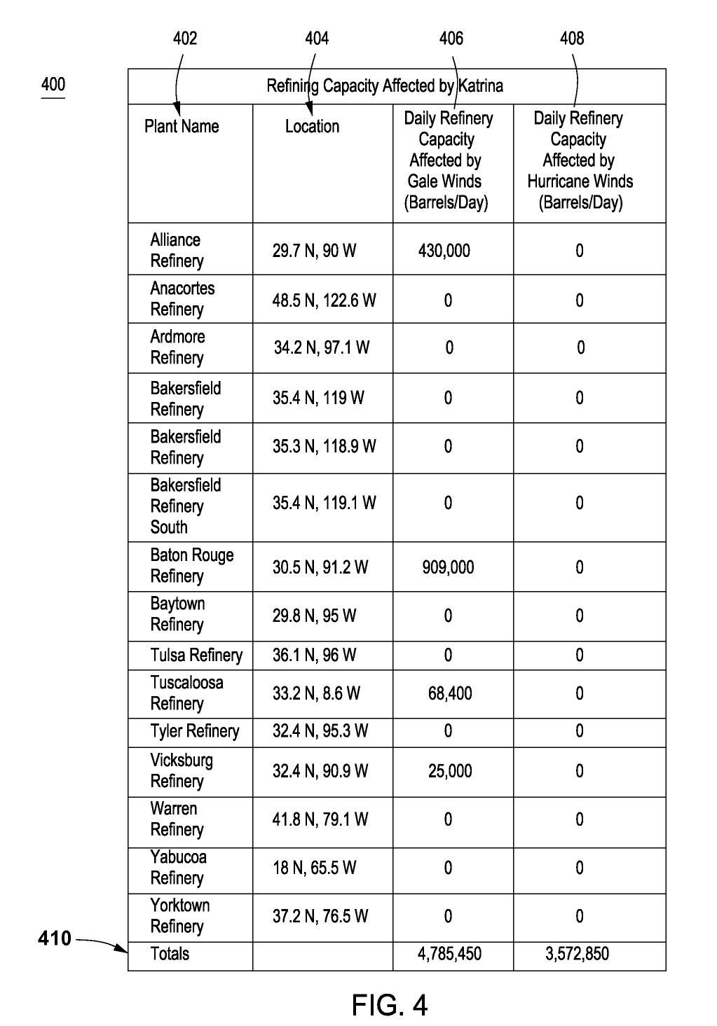

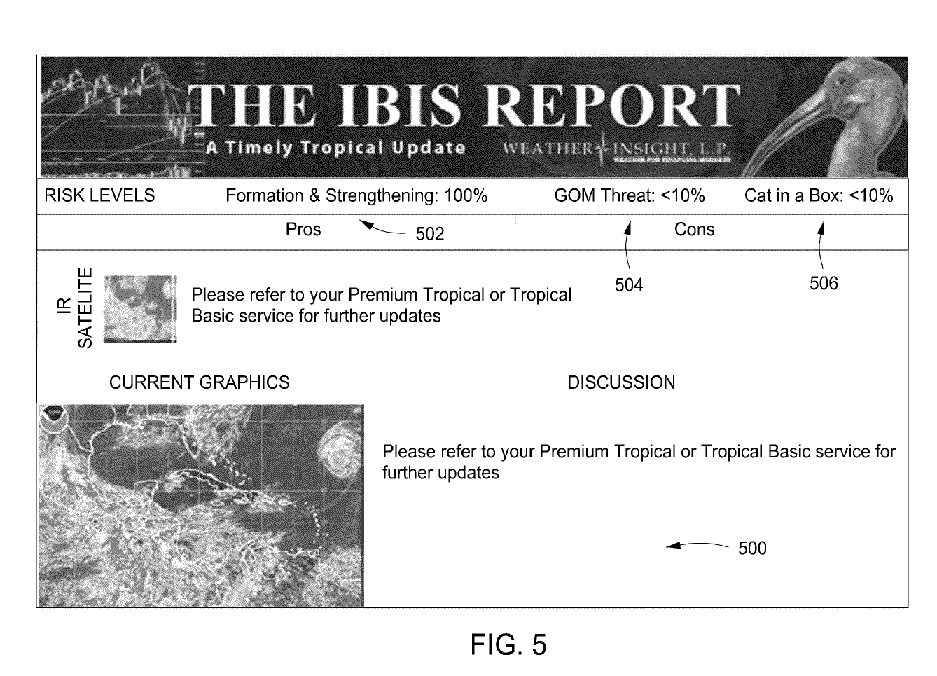

As illustrated in FIGS. 2-5, at least a few categories of GUI screens are available for viewing weather forecast data as it relates to commodity trading. For example, a user may be able to geographically track forecasted storms (FIG. 2), analyze predicted losses in production or output (FIGS. 3 and 4), and view various analyses regarding the probability that a Tropical Atlantic-based storm will affect the Gulf of Mexico region (FIG. 5).

Another way to deliver to the user 102 the data that has been compiled and processed by the forecast data server 110 is via a user input module 120 communicably coupled to the communication module 116. In an exemplary embodiment, the user input module 120 may act to filter out forecast data received from the communication module 116 and not requested by the individual user 102 or to which the user 102 is not entitled. In other exemplary embodiments, the communication module 116 and the user input module 120 may be combined into a singular module or may include several other modules conveniently housed in the OC 110.

The module 120 may allow at least one user-defined parameter provided by the user 102 to designate, for example, a specific commodity forecast in light of an impending tropical system, including tropical storms and hurricanes. Through the user interface 104, a user 102 may be capable of defining and setting forecast parameters that meet a specific commodity trading need. For example, user-defined parameters may include various information related to forecasted production impacts, weather forecasts, geographic identifiers, one or more temperature identifiers, each designed to alert the user 102 in the event the temperature in a specific geographic region fluctuates to a pre-determined critical reading, or any combination thereof. Moreover, a user 102 may set parameters relative to weather events such as warm or cold weather, or even tropical storm activity. Thus, the user input module 120 allows the customized receipt of data such that an individualized storm forecast is transmitted to each user 102, thereby delivering to the user 102 only what is asked for as opposed to alerting the user 102 constantly with data updates that are unrelated to the user's 102 trading vision.

In an exemplary embodiment, after filtering the forecast data to the user-defined parameters, the module 120 may be capable of disseminating information to the user 102 by at least two methods. First, a user 102 may elect to receive customized alerts 122 designed for users 102 who choose to be alerted when predetermined storm criteria and/or forecast data and parameters have been met. Once processed and prepared by the OC 106, these alerts 122 may be distributed via a variety of formats. For example, in at least one embodiment, alerts 122 may be written in syntax sentence form and forwarded to predetermined users 102 who have requested specific storm or forecast information when certain parameters are met. Thus, alerts 122 may be available to a user 102 through pop-up messaging, e-mail, instant messaging services, text messaging, a BlackBerry® device, or any other hand-held digital device, allowing users 102 to receive real-time, current commodity forecast information directly on the floor of an exchange if needed.

A second way to distribute the information from the user input module 120 is via real-time data (RTD) updates 124, in the form of a computer-generated spreadsheet display. In general, “real-time data” denotes information that is delivered immediately after collection, e.g., there is essentially no delay in the timeliness of the information provided. In an exemplary embodiment, current and updated weather data may be made available to the weather information database 112 at predetermined time intervals. As such, an RTD server may automatically and continuously poll or check the weather information database 112 for updated weather information around these predetermined time intervals so that once the data is made available, an RTD update 124 may immediately be acquired by the forecast data server 110 and pushed to the user 102 via a Microsoft Excel® spreadsheet or a similar format.

As further explanation, real-time data technology generally allows a user 102 to rearrange and manipulate the data received throughout various cells or other regions of a spreadsheet. Particularly, Microsoft Excel® provides a worksheet function, generally referred to as “RTD”, that allows a user to assign a particular cell in a spreadsheet to a value, where the value is determined by calling a server and retrieving data associated with the particular cell. In an exemplary embodiment, the RTD update feature may be designed to allow preconfigured Microsoft Excel® spreadsheets to retrieve weather forecast data through a standard real-time data server which automatically updates specific cells. The spreadsheet containing the real-time data may be configured to continually update based upon the most recent data available. The interval for updating the spreadsheet may be predetermined by the user 102. As such, the spreadsheet data may be dynamic in that the information may be continuously changing to reflect the most recent weather or storm data available as constantly updated through sources such as the weather information database 112. In one embodiment, this process may be continuous while the Excel® spreadsheet is active (i.e., open), thus providing a user 102 who is trading commodities with a spreadsheet containing trading-specific weather information that is constantly updated to reflect the latest forecasts.

As can be appreciated, the present disclosure contemplates several other methods of distributing the information to users 102 as is known in the art, including streaming video.

Referring now to FIG. 2, illustrated is an exemplary graphical user interface (GUI) 200 that may be provided to a user 102 from the communication module 116, as described above. In particular, the GUI 200 may be delivered to a user 102 via a monitor (not illustrated) that is connected to the user interface 104, or via a PDA or similar device. As illustrated, the GUI 200 depicts and provides to a user 102 the projected path of an exemplary tropical system forming in the Gulf of Mexico. For purposes of illustration and explanation related to the several potential embodiments of the present disclosure, the GUI 200 illustrates the storm forecast for Hurricane Katrina which made landfall at New Orleans, La., USA in 2005.

As shown in FIG. 2, the eye of the storm 202 is represented along with its projected storm trajectory points 204 depicted in this embodiment by a series of squares. A typical storm trajectory can be forecasted anywhere from 5-15 days into the future. In at least one embodiment, the storm trajectory points 204 may be sequentially ordered in six hour increments, meaning that it will take approximately six hours for the eye of the forecasted storm 202 to reach the next trajectory point 204. By clicking on the Move 6 Hours button 204a, the GUI 200 may be configured to animate the storm and move the eye of the storm 202 to the next storm trajectory point 204, or move the eye 202 six hours into the future forecast. Moreover, by clicking the Move to End button 204b, the GUI 200 may be configured to animate the storm and move the eye of the storm 202 through all mapped trajectory points 204, potentially animating the eye of the storm 202 to 5-15 days from the current position according to the weather forecasts.

As illustrated, the forecasted storm trajectory may also include a 60% probability zone of confidence 206 and a 40% probability zone of confidence 208. As explanation, the 60% zone 206 may indicate the geographic area where the storm has a forecasted 60% chance of affecting if it follows the projected storm trajectory 204. Similarly, the 40% zone 208 may indicate the geographic area where the zone has a forecasted 40% chance of affecting if it follows the projected storm trajectory 204.

Also illustrated in the GUI 200 may be a series of concentrically-disposed wind intensity rings 210, 212 surrounding the eye of the storm 202. Each wind intensity ring 210, 212 may be color-coded and thereby represent the varying wind intensity conditions present in the areas contained therein. For example, the outer-most wind intensity ring 210 may indicate winds ranging from about 25-38 mph, while the inner-most wind intensity ring 212 may indicate winds of 100+ mph. As can be appreciated, the wind intensity rings disposed between the outer-most and inner-most rings 210, 212 may indicate varying ranges of wind intensity, generally decreasing in intensity as they reach farther out from the eye of the storm 202

Also illustrated in the GUI 200 may be all the existing oil and natural gas refineries 214 surrounding the Gulf of Mexico area. In at least one embodiment, the size of the refinery 214 icon may be representative of the size (i.e., crude oil refining capacity) of the refinery. For example, a larger refinery icon 214a may indicate a refinery with a larger crude oil refining capacity, while a smaller refinery icon 214b may indicate a refinery with a smaller refining capacity. In an exemplary embodiment, if the GUI 200 shows the refinery icon 214 blinking, it may be considered “offline,” meaning that production at that particular refinery has either been severely reduced or halted altogether. In exemplary operation, the user 102 may be able to move the mouse cursor over any of the displayed refineries 124 to initiate a pop-up window (not shown) configured to provide basic refinery details. Such details may include the refinery name, ownership information, and production capacity (i.e., how many barrels of oil and/or BCF of natural gas are refined and produced in the facility).

Also illustrated are the major deep-water offshore production facilities 216, including crude oil and natural gas producing facilities and active platforms (facilities). Although there are thousands of offshore facilities in the Gulf of Mexico region, the illustrated embodiment only displays deepwater facilities, and/or facilites that meet and exceed a particular production capability so as to constitute a significant amount of the overall oil/gas production in the region. In other embodiments, a user 102 may be able focus in or “zoom in” on a certain area to reveal all oil/gas producing facilites in that region, even low production capability facilities. By moving the cursor over each indicated offshore facility 216, a pop-up window (not shown) may be initiated to provide the user 102 with details regarding the particular facility 216. Such details may include the name of the facility, facility ownership information, and how many barrels of oil and/or BCF of natural gas are produced at that site. As explained above, these production numbers and statistics are all publicly available and disseminated on a periodic bases through the Minerals Management Service, an agency of the U.S. Government, who requires drillers by law to report production numbers.

GUI 200 of FIG. 2 may also depict the generalized lease regions for the outer continental shelf of the Gulf of Mexico (i.e., the gridwork as shown in the Gulf of Mexico waters), as is known in the art. In an exemplary embodiment, each lease region may include a lease region indicator 218. If the user 102 moves the cursor over a particular lease region indicator 218, a pop-up window may be initiated (not shown) to provide the user 102 with general lease region information. Such information may include the official name of the lease region and the aggregate daily production of all crude oil and/or natural gas produced (per day) in that region (represented as a dark square located in the center of each lease area). The aggregate production total includes all the offshore producing facilities 216 in the specific lease region, not just the major-producing facilities as shown in the illustrated embodiment (i.e., white squares), thus including the several smaller offshore facilities located above the continental shelf divide.

Still referring to FIG. 2, by clicking the Production button 220, a user 102 may be able to view, among other things, the predicted short-term and long-term offshore production outages that may result from the forecasted storm (see FIG. 3). In other words, since the forecasted storm trajectory proceeds over several oil/gas facilities, the present disclosure may be able to aggregate and calculate how much oil/natural gas production may potentially be affected in a lease area, depending on the forecasted winds and waves that the specific production facility would encounter from the tropical system. Similarly, by clicking the Refining button 222, the user may be provided with forecasted crude oil refining levels depicting the extent that oil/gas refineries in the Gulf of Mexico region may be affected by the forecasted trajectory of the storm (see FIG. 4).

Referring now to FIG. 3, illustrated is an offshore production table GUI 300, accessible by the user 102 through the GUI 118 feature of the communication module 116 (FIG. 1), and by clicking the Production button 220 (FIG. 2). Particularly, GUI 300 may be available to the user 102 through the user interface 104, as described above. The GUI 300 may provide the user 102 with calculations reflecting how the currently forecasted storm (see FIG. 2) will potentially affect oil and gas production in the Gulf of Mexico region. In other embodiments, these same calculations, including production numbers for refineries or production facilities, may be transmitted to users 102 via the real-time update 124 spreadsheet format, as described above.

As can be seen, GUI 300 may first provide a series of columns and rows. One column may include the official name of the several lease regions 302, while another may provide the geographical coordinates 304 for the named lease region listed in the same row. Other columns may provide estimated short-term 306a, 306b and susceptible long-term 308a, 308b production outages of oil and natural gas production in light of a forecasted tropical storm. Bearing in mind that the data contained in GUI 300 directly reflects the storm trajectory as explained with reference to FIG. 2, the values displayed in columns 306a-b and 308a-b represent the potential losses for each lease area 302 in view of the impending forecasted storm. Thus, the lease areas 302 that report “0” losses in columns 306a-b and 308a-b are likely not in the projected path of the impending storm, neither in the 60% probability zone of confidence 206 nor the 40% probability zone of confidence 208 (see FIG. 2).

The short-term and long-term production outages for each lease region may be calculated based on several variables, such as the forecasted wave height and wind speed for each drilling facility contained in that region, then aggregated to a regional total. These various forecast variables are typically provided by the same meteorological sources that the weather information database 112 (FIG. 1) trolls to download the latest forecasts to the forecast data server 110 in real-time as well as proprietary weather forecasts from in-house meteorologists. Other meteorological variables, along with engineering details related to each specific drilling facility, may be included in the short-term 306a, 306b and long-term 308a, 308b outage calculations, such as facility or platform age, water depth in the region, retro fittings on the facility, historical outages of the facility, etc. As illustrated in GUI 300, columns 306a, 306b may provide a user 102 with the short-term shut-in forecasts for oil and gas production, respectively, in the Gulf of Mexico region.

A platform or facility may be susceptible to a short-term shut-in 306a-b if its region is forecasted to endure winds of at least 25 mph (i.e., gale force winds), but no more than 100 mph, and waves not exceeding 45 ft in height. Depending on the severity of the conditions, these instances generally result in total facility shutdown and evacuation, thereby halting oil and gas production for a short term. When the crew returns from evacuation, the facility may restored online in a matter of a few days, thus resuming production. In general, a short-term evacuation involves the crew and engineers returning to the facility or platform and being able to resume production within a few days. Although evacuation procedures vary from facility to facility, and from production company to production company, the calculations made in the present disclosure employ the average conditions when all facilities or platforms are typically evacuated based on forecasted weather variables, as described above.

On the other hand, if a facility or platform is forecasted to endure winds greater than 100+ mph (i.e., hurricane force winds) and waves in excess of 45 ft, the facility or platform will likely be susceptible to long-term damage. In these instances, not only are the facilities evacuated for safety reasons, but they are commonly out of commission for several weeks, or longer, following the storm, while the crew and engineers repair damaged equipment and get all systems up and running again. In some instances, the facilities are so severely damaged that they cannot be recovered for months. In those cases, the oil and/or gas production would be put on permanent hold until new equipment or a whole new facility is installed. In general, a long-term evacuation that results in long-term damage involves the inability to resume production or place the facility in operational status within an average of 2 weeks.

Also illustrated in the GUI 300 may be the Total GOM Production 310 numbers, representing the current oil and natural gas production for the entire Gulf of Mexico (“GOM”) region. These total production 310 numbers represent the total possible amount of oil and natural gas production added from all Gulf of Mexico lease regions on any given day. For example, as illustrated, the Total GOM production 310 for oil is 1,269,826 barrels per day, and for natural gas is 7.4 BCF per day. In an exemplary embodiment, these production numbers are continuously updated by the commodity production database 114 (FIG. 1) as it receives updated information through the various information outlets, such as the Minerals Management Service. As can be appreciated, these numbers may continuously fluctuate as new platforms are moved into the region or wells cease production.

The Total GOM Production 310 row of numbers are to be directly contrasted with the Total Affected 312 row of numbers, which report the forecasted potential losses of oil and/or gas production in view of short-term damage 306a-b, or long-term damage 308a-b. The Total Affected 312 row of numbers may simply reflect the addition of the forecasted potential losses reported in columns 306a-b and 308a-b. By contrasting the numbers in the Total Affected 312 row with the numbers in the Total GOM Production 310 row, a user 102 is able to ascertain the severity of the forecasted storm and conduct commodity trades accordingly.

In other embodiments, the GUI 300 may also include columns (not shown) that indicate the percentage of GOM production affected, derived by dividing the forecasted production outages 306a-b and 308a-b by the Total GOM Production to represent percentage of GOM Production. Moreover, another column (not shown) may indicate the percentage of U.S. production affected, derived by dividing the forecasted production outages 306a-b and 308a-b by the Total U.S. production numbers.

As illustrated in FIG. 3, in light of the forecasted storm, the calculations in the Total Affected 312 row of numbers approximates that 1,193,377 barrels of oil per day and 6.2 BCF of natural gas per day will potentially be lost in all GOM lease regions 302 where sustained winds of 25 mph will require short-term outages 306a-b. On the other hand, the calculations in the Total Affected 312 row of numbers approximates that 704,178 barrels of oil per day and 3.0 BCF of natural gas per day will potentially be lost in all GOM lease regions 302 where hurricane force winds will require long-term outages 308a-b. Said differently, 1,193,377 barrels of oil per day and 6.2 BCF of natural gas per day are forecasted to be lost for production for only a short term, but 704,178 barrels of oil and 3.0 BCF of natural gas per day are forecasted to be lost on a long-term basis, and may not recuperate for months. As can be appreciated, knowing these forecasted values and receiving this information in near real-time may prove quite advantageous to a user 102 who trades energy commodities and may take advantage of long-term outlook pricing.

Referring now to FIG. 4, illustrated is a refinery GUI 400, accessible by the user 102 through the GUI 118 feature of the communication module 116 (FIG. 1) by clicking the Refining button 222 (FIG. 2). GUI 400 may be configured to provide a user 102 with forecasted statistical data depicting the extent that crude oil refineries in a particular region may be affected by the forecasted trajectory of the storm (see FIG. 2). In an exemplary embodiment, the GUI 400 may depict forecasted refining capacity for the crude oil refineries located in the Gulf of Mexico region. Similar to GUI 300, GUI 400 may include a series of columns and rows, where one column may include the official name of the refinery 402, while another may provide the geographical coordinates 404 for the named refinery listed in the same row.

Other columns may provide estimated short-term 406 and susceptible long-term 408 production outages for the refineries in light of the forecasted tropical system. Once again, bearing in mind that the data contained in GUI 400 directly reflects the storm trajectory as explained with reference to FIG. 2, the values displayed in columns 406 and 408 represent the potential losses in production for each refinery 402 in view of the impending forecasted storm. Thus, the refineries 402 that report “0” losses in columns 406 and 408 are likely not located in the projected path of the impending storm, neither in the 60% probability zone of confidence 206 nor the 40% probability zone of confidence 208 (see FIG. 2). GUI 400 may also include a Totals 410 row of numbers that may be configured to add up the potential refining losses that are forecasted in columns 406 and 408, respectively, and report them at the bottom. Therefore, the Totals 410 row of numbers may reflect the total barrels of oil refined per day that may be affected in the region as a result of the storm trajectory and potential damage or shut-down that may transpire.

As can be appreciated, other embodiments of the present disclosure contemplate multiple data tables that may be accessed from GUI 200 in FIG. 2 and are provided to a user 102 to reflect the potential damages to any energy-producing or any energy-refining facility in the specific region contemplated. This may include such facilities as chemical terminals, pipelines, nuclear power plants, transmission lines, coal power plants, etc.

Using similar forecast calculations for tropical systems in the Gulf of Mexico, a graphical user interface that calculates the probability of multiple facets of Gulf of Mexico weather patterns is also disclosed herein. Particularly, referring to FIG. 5, illustrated is a tropical system reporter 500 that may also be distributed to a user 102 via the GUI 118 method of the communication module 116 (FIG. 1). In other embodiments, various informational pieces of the tropical system reporter 500, or the whole report 500 itself, may be distributed to a user 102 in syntax form in real-time through the filtering user input module 120.

In an exemplary embodiment, the tropical system reporter 500 may be configured to track systems forming in any region of the world. In at least one embodiment, the tropical system reporter 500 may be configured to track tropical weather systems forming in the Atlantic Ocean region and potentially headed toward the Gulf of Mexico. The refining capacity reported in the reporter 500 may be continuously updated by the weather information database 112 as downloaded to the forecast data server 110 and also delivered via the real-time technology of the forecast data server 110 into a spreadsheet for user 102 reference, as described above. The reporter 500 may also be configured to provide the user 102 with tropical system upgrade and/or downgrade alerts, consistent with the customized alerts 122 criteria as explained above.

Based on publicly available meteorological data, the reporter 500 may prognosticate the probability that the storm will develop into a tropical storm or worse 502, whether the storm is likely to enter the Gulf of Mexico region 504, and whether the storm will turn into a categorized hurricane and enter an offshore oil/gas producing region named the “cat-in-the-box” region 506. The “cat-in-the-box” region runs from Galveston, Tex., USA to Mobile, Ala., USA and is a financially traded futures contract at the Chicago Mercantile Exchange (CME). In process, if a Category storm (regardless of whether it is a 1 to a 5) enters the “cat-in-the-box” region as defined specifically by the CME, the financial contract then pays out. In essence, traders are able to place bets on future weather patterns in this Gulf of Mexico region, which encompasses the majority of the offshore oil fields and drilling facilities in the Gulf of Mexico.

In the illustrated exemplary embodiment of FIG. 5, the probability that the selected current storm will develop into a tropical depression or hurricane 502 is 100%, meaning that it has been confirmed by a meteorological source, such as the National Hurricane Center (NHC), as such. Likewise, the probability that storm will threaten the waters of the Gulf of Mexico 504 is less than 10%, meaning that it is highly unlikely that the storm will reach the Gulf area. Lastly, the probability that the storm will enter the “cat-in-a-box” region 506 is also highly unlikely at less than 10%. These percentages are calculated by trained meteorologists who take many weather models and meteorological conditions into consideration to calculate a target probability. There are around 20-30 variables that the meteorologists take into consideration in making predictions.

The report 500 also provides the user 102 with “pros” and “cons” related to system formation, meaning the meteorological drivers that would either strengthen (“pros”) or weaken (“cons”) the system. These include such weather factors as high pressure systems, water temperature, wind sheer, convection, vorticity, and even dust present in the regional atmosphere. As can be appreciated, having this information readily available allows a user 102 to execute informed trading decisions when it comes to dealing with potential oil/gas production or refinery losses in a specified region of the world where a tropical storm may develop and disrupt energy supply.

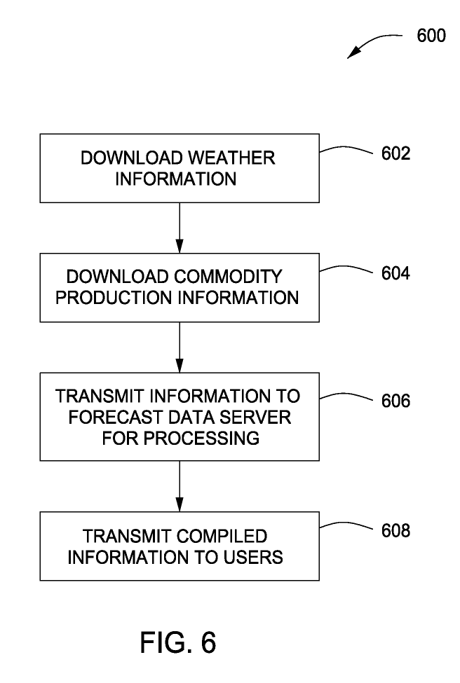

Referring now to FIG. 6, there is illustrated an exemplary method 600 for compiling and transmitting weather-related data to users. The method may include downloading information from a public weather information database or uploading forecast information from proprietary weather forecasters. The public weather information database may be a database that is continuously or periodically in communication with the United States National Weather Service, as at step 602. The information downloaded by the weather information database may include up to the minute weather forecast information received in near real-time, including the projected trajectory of a tropical storm forming in the Tropical Atlantic Ocean region and potentially migrating into the Gulf of Mexico. The method 600 may also include downloading commodity production information from a variety of publicly available sources, as at step 604. The commodity production information may include oil and gas production numbers, power-generating facility information, and current production/output outages.

Both the weather information database and the commodity production database may then transmit their respective information packages to a forecast data server for processing, as at step 606. The forecast data server may be configured to receive and process the information obtained from the weather information and commodity production databases. In particular, the forecast data server may process and compile the forecast information in conjunction with the commodity production information to determine possible short-term shut-in or susceptible long-term damages for commodity production/output lying in the forecasted trajectory of the storm. The process and compiling may include executing a plurality of algorithms configured to sort and/or prioritize the weather data and forecasts based on, among other variables, forecasted wave height and wind speed.

Once the data has been processed and compiled, the method of the disclosure may proceed to transmit the compiled information to selected users, as at step 608. In at least one embodiment, the users may include commodity traders of various energy-related instruments which trade around the world. The compiled information may be transmitted to selected users via a variety of means, including, but not limited to, personalized alerts, at least one graphical user interface viewable through at least a monitor of a user interface, and real-time data updates, as explained herein. As part of the process of transmitting the compiled information to the selected users, individual users may be able to specify pre-determined parameters, forecasts, or portions of data that they wish to receive in various selected formats, so as to ultimately receive a personalized forecast tailored to the commodity trading needs of the user.

Another exemplary embodiment of the present disclosure may provide a software package configured to control the method described above.

Another embodiment of the invention may provide a system for acquiring, generating, and transmitting whether data and commodity forecast information to selected users as it pertains to the trade of energy commodities. The system may include a user input module, a forecast data server module, and a communication module, all of which may be in communication with remotely positioned weather information and commodity production databases. The system may be configured to receive weather and forecast information from the weather information database, and current production/output information from the commodity production database, and process and compile the collective information in accordance with predetermined algorithms to calculate possible losses in oil and gas production and power generation in light of a forecasted storm trajectory. The system then may then transmit this compiled commodity forecast information to selected users.

Although the bulk of the present disclosure depicts tropical system forecasts and calculations based on Gulf of Mexico tropical storms and hurricanes, nothing in this disclosure is to limit the use of this technology in other areas of the world. Indeed, the technology can be practiced anywhere there is sufficient data to support the system and method disclosed herein.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

We claim:

1. A method for compiling and transmitting weather-related data to a user, comprising:
downloading weather information from a weather information database communicably coupled to a forecast data server, wherein the weather information includes a forecasted trajectory of a system;
downloading commodity production information from a commodity production database communicably coupled to the forecast data server;
transmitting the weather information and commodity production information to the forecast data server;
processing the transmitted weather information and commodity production information to determine possible short-term shut-in or susceptible long-term damages for offshore oil or natural gas facilities lying in the forecasted trajectory of the system, wherein a commodity forecast is obtained; and
transmitting the commodity forecast to the user in real-time via a communication module, wherein the user may specify at least one pre-determined parameter so as to receive a personalized commodity forecast.

2. The method of claim 1, wherein the weather information database is in continuous communication with the National Weather Service.

3. The method of claim 1, wherein the commodity production database is in continuous communication with the Minerals Management Service.

4. The method of claim 1, wherein the forecasted trajectory of a system may include the projected trajectory of a tropical storm or hurricane forming in the Atlantic Ocean region and potentially migrating into the Gulf of Mexico.

5. The method of claim 1, wherein the commodity production information includes current crude oil and natural gas production information at refineries located in the Gulf of Mexico region.

6. The method of claim 1, wherein the commodity production information includes current power generation information at power plants located in the Gulf of Mexico region.

7. The method of claim 1, wherein processing the transmitted weather information and commodity production information includes executing a plurality of algorithms configured to sort or prioritize the weather information and commodity production information based on variables such as forecasted wave height and wind speed.

8. The method of claim 1, wherein transmitting the commodity forecast includes sending real-time personalized alerts to the user via a hand-held device or personal computer.

9. The method of claim 1, wherein transmitting the commodity forecast comprises providing at least one graphical user interface viewable by the user through a monitor communicably coupled to a user interface, wherein the at least one graphical user interface is transmitted to the user via real-time data updates, in the form of a computer-generated spreadsheet display

10. The method of claim 9, wherein the at least one graphical user interface depicts and provides to the user a geographical representation of the projected path of the forecasted trajectory of a system forming in the Gulf of Mexico.

11. The method of claim 9, wherein. the at least one graphical user interface provides the user with a table configured to reflect how the forecasted trajectory of a system will affect oil and gas production in the Gulf of Mexico region.

12. The method of claim 9, wherein the at least one graphical user interface provides the user with a table reflecting forecasted refining capacity depicting how oil refineries in the Gulf of Mexico region may be affected by the forecasted trajectory of a system.

13. The method of claim 9, wherein the at least one graphical user interface provides the user with a computer-generated spreadsheet display indicating real-time production numbers for refineries and production facilities.

14. A system for compiling and transmitting weather-related data to a user, comprising:
a forecast data server;
a weather information database communicably coupled to the forecast data server and configured to provide the forecast data server with near real-time weather forecasts, including a forecasted trajectory of an impending tropical system, wherein the weather information database is stored on a computer-readable medium;
a commodity production database stored on a computer-readable medium, communicably coupled to the forecast data server, and configured to transmit to the forecast data server production information relating to crude oil and natural gas production for offshore facilities and/or refineries, wherein the forecast data server is configured to process the information received from the weather information database and commodity production database to obtain a commodity forecast; and
a communication module communicably coupled to the forecast data server and configured to distribute the commodity forecast to the user in real-time.

15. The system of claim 14, wherein the weather information database receives the weather forecasts from the National Weather Service.

16. The system of claim 14, wherein the forecasted trajectory of an impending tropical system may include the projected trajectory of a tropical storm or hurricane forming in the Tropical Atlantic Ocean region and potentially migrating into the Gulf of Mexico.

17. The system of claim 14, wherein the communication module distributes the commodity forecast to the user via at least one graphical user interface viewable on a monitor communicably coupled to a user interface.

18. The system of claim 17, wherein the at least one graphical user interface depicts a geographical representation of the projected path of the forecasted trajectory of an impending tropical system.

19. The system of claim 17, wherein the at least one graphical user interface provides a table configured to reflect how the forecasted trajectory of an impending tropical system will adversely affect oil and gas production in the Gulf of Mexico region.

20. The system of claim 17, wherein the at least one graphical user interface provides a table reflecting forecasted refining capacity depicting the extent that oil refineries in the Gulf of Mexico region may be adversely affected by the forecasted trajectory of an impending tropical system.

21. The system of claim 14, further comprising a user input module communicably coupled to the communication module and configured to filter the commodity forecast according to pre-determined specifications provided by the user, thereby delivering to the user an individualized forecast.

22. The system of claim 21, wherein the individualized forecast is deliverable to the user via customized alerts received through a network and onto a hand-held digital device or personal computer.

23. The system of claim 21, wherein the individualized forecast is deliverable to the user via real-time data updates in the form of at least one computer-generated spreadsheet.

24. The system of claim 14, wherein the production information transmitted to the forecast data server includes current power generation information at power plants located in the Gulf of Mexico region.

25. The system of claim 14, wherein the forecast data server processes the information received from the weather information database and commodity production database by executing a plurality of algorithms configured to sort and/or prioritize the weather information and commodity production information based on, among other variables, forecasted wave height and wind speed.

26. The system of claim 13, wherein the communication module is further configured to distribute a tropical storm report that tracks and reports on tropical systems forming in any region of the world.
